(19) United States
(12) Patent Application Publication
(10) Pub. No.: US 2006/0079181 A1
(43) Pub. Date: Apr. 13, 2006

(54) Bluetooth CTP mobile telecommunication terminal, bluetooth CTP gateway, and connection method thereof

(75) Inventors: Chan Phill Yun, Seoul (KR); Min Jung Kim, Seoul (KR); Jin Ho Son, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/245,925

(22) Filed: Oct. 7, 2005

(30) Foreign Application Priority Data
Oct. 8, 2004 (KR) 2004-0080553

(51) Int. Cl. H04B 7/00; H04B 1/40

(52) U.S. Cl. 455/41.2; 455/74.1

(57) ABSTRACT

A bluetooth CTP (Cordless Telephony Profile) mobile telecommunication terminal, a bluetooth CTP gateway, and a connection method thereof are provided such that the function of both a wire telephone and a wireless telephone are enabled in one mobile telecommunication terminal. A CTP terminal attempts a CTP connection to a CTP gateway only upon receiving a bluetooth profile from the CTP gateway, the profile requesting the CTP connection. Even when the position of the CTP gateway is changed, there is no need to re-register the new CTP gateway position in the CTP terminal and electric power consumption of the CTP terminal may be reduced. Since connection between the CTP terminal and the CTP gateway is implemented using only bluetooth technology, additional costs incurred due to use of another technology are reduced and a lower price may be achieved.

### CROSS-REFERENCE TO RELATED APPLICATIONS

Pursuant to 35 U.S.C. § 119(a), this application claims the benefit of earlier filing date and right of priority to Korean Application No. 2004-0080553, filed on Oct. 8, 2004, the contents of which is hereby incorporated by reference herein in its entirety:

### BACKGROUND OF THE INVENTION

1. Field of the Invention

The present invention relates to a bluetooth CTP (Cordless Telephony Profile) mobile communication terminal. More particularly, the present invention relates to a bluetooth CTP mobile telecommunication terminal, a bluetooth CTP gateway and a connection method thereof, wherein a CTP gateway requests CTP connection to a CTP terminal by using an SPP (Serial Port Profile) and the CTP terminal attempts CTP connection to the CTP gateway only when the CTP terminal receives the SPP.

2. Description of the Related Art

Recently, wireless telecommunication devices have been integrated. Such integration allows one mobile telecommunication terminal to function as both a wire telephone with high sound quality at low price and as a wireless telephone with which a telephone call may be made regardless of a user's location.

Such a terminal is referred to as a CTP terminal. For a user's convenience, a CTP terminal provides an automatic connection function to automatically connect the terminal to a wire telephone gateway by utilizing an algorithm provided by the terminal rather than the user's input.

Since the number of conventional CTP terminals registered in a CTP gateway cannot be known, only the function of attempting to connect the CTP terminal to the CTP gateway is provided. Although a bluetooth function may vary depending on the manufacturer providing a chip, electric power of about 1 to 2 mA per second is generally consumed on standby for CTP connection and electric power of about 70 to 120 mA per second is consumed for attempting CTP connection to a CTP gateway.

However, power consumption of greater than 70 mA per second has a great influence on the decrease in standby time of a mobile telecommunication terminal in view of characteristics of the terminal. Therefore, a conventional mobile telecommunication terminal using CDMA (Code Division Multiple Access) technology attempts to solve the aforementioned problem by searching an approximate location of its own position at every predetermined time and then attempting the CTP connection to a CTP gateway only when the location of the terminal is similar to that of the CTP gateway. However, conventional mobile telecommunication terminals have several disadvantages.

First, extraneous technology rather than bluetooth technology is used to connect two bluetooth devices (a CTP terminal and a CTP gateway). For example, CDMA technology is used to locate a current position of a CTP terminal. Although the position of a terminal may be located using, for example, GPS (Global Positioning System) technology in addition to CDMA technology, additional costs are incurred, such as royalties on CDMA technology and the built-in costs of GPS devices.

Second, since a terminal attempts CTP connection to a CTP gateway at every a predetermined period (T) of time in order to reduce power consumption when attempting to connect to a device, the terminal may be connected to the CTP gateway for anywhere up to a maximum time (T) if a user frequently moves about the border of an area in which bluetooth connection can be made. Therefore, the user cannot gain immediate access to a landline even though the user enters the radius of the CTP gateway and user inconvenience is increased.

Third, since a CTP terminal uses a position of a CTP gateway to connect to the CTP gateway, a user must change the position of the CTP gateway stored in the CTP terminal by means of an additional setting process if the position of the CTP gateway is changed. In other words, since information related to a cell where a CTP gateway is positioned is stored in a CTP terminal when the CTP terminal is registered in the CTP gateway, movement of the CTP gateway to another cell requires that information related to the new position of the CTP gateway be re-registered in the CTP terminal in order that the terminal function as a wire telephone.

Fourth, if the position of a CTP gateway is in an area where cells overlap, it is difficult for a CTP terminal to detect the position of the CTP gateway. Furthermore, if the size of a cell where the CTP gateway is positioned is increased, the CTP terminal is forced to make frequent attempts to connect to the CTP gateway and power consumption increases.

Therefore, there is a need for a system for efficiently connecting a bluetooth CTP mobile communication terminal to a CTP gateway such that the terminal may immediately be used as a wire telephone. The present invention addresses these and other needs.

### SUMMARY OF THE INVENTION

The present invention is directed to a bluetooth CTP mobile telecommunication terminal, a bluetooth CTP gateway, and a connection method thereof such that there is no need to re-register the new position of the CTP gateway in a CTP mobile telecommunication terminal when the position of the CTP gateway is changed, thereby reducing the power consumption of the CTP mobile telecommunication terminal. In order to accomplish the objects of the present invention, a CTP gateway requests CTP connection to a CTP terminal by using an SPP (Serial Port Profile) and the CTP terminal attempts CTP connection to the CTP gateway only when the CTP terminal receives the SPP.

It is an object of the present invention to provide a bluetooth CTP mobile telecommunication terminal, a bluetooth CTP gateway, and a connection method thereof, wherein a CTP gateway differentiates the number of connection attempts among respective CTP mobile telecommunication terminals by applying weighted factors to the respective CTP mobile telecommunication terminals so that a user can immediately use the wire telephone function of a CTP mobile telecommunication terminal when the user enters the radius of the CTP gateway. It is another object of the present invention to implement a connection between a CTP mobile telecommunication terminal and a CTP gateway using only bluetooth technology, thereby reducing additional costs incurred when technologies such as CDMA or GPS are used.

According to an aspect of the present invention, a method of connecting a bluetooth CTP mobile telecommunication terminal to a bluetooth CTP gateway is provided. The method includes the steps of the CTP gateway transmitting a bluetooth profile for requesting a CTP connection attempt to one or more bluetooth CTP mobile telecommunication terminals registered in the bluetooth CTP gateway and the terminals attempting a CTP connection to the gateway upon receiving the bluetooth profile. Preferably, the method further includes using a wire telephone network through the CTP gateway when the CTP connection is made between a CTP mobile telecommunication terminal and the CTP gateway.

The bluetooth profile may be a SPP (Serial Port Profile). The CTP gateway may set a weighted factor for a connection attempt to differentiate the number of requests for the connection attempt for each of the registered CTP mobile telecommunication terminals.

The setting of the weighted factor for a connection attempt may include a method based on the frequency of connection to the CTP gateway or a method based on whether the CTP terminal has been connected within a predetermined period of time, with the time based on a point in time where the connection attempt was made. In addition, the weighted factor for a connection attempt may be selected from among one or more grades and the number of requests for a connection attempt may increase or decrease by a predetermined multiple between successive grades.

If a plurality of bluetooth CTP mobile telecommunication terminals are registered in the CTP gateway, the CTP gateway may request the CTP connection attempt multiple times up to a maximum. Preferably, the maximum is the sum of the numbers of connection attempts corresponding to the weighted factors of the registered CTP mobile telecommunication terminals. Preferably, the CTP gateway requests the CTP connection attempts during a time (t) obtained by excluding a CTP connection standby time (T-t) from a predetermined period of time (T).

A bluetooth CTP mobile telecommunication terminal of the present invention may use a wire telephone network by making CTP connection to a bluetooth CTP gateway that is connectable to the wire telephone network. Specifically, the bluetooth CTP mobile telecommunication terminal attempts the CTP connection to the bluetooth CTP gateway when the terminal receives a bluetooth profile transmitted from the bluetooth CTP gateway for requesting the CTP connection attempt.

A bluetooth CTP gateway of the present invention may be connected to a wire telephone network and one or more bluetooth mobile telecommunication terminals. The gateway provides connection to the wire telephone network when the CTP gateway is connected through CTP connection to a registered bluetooth CTP mobile telecommunication terminal. The bluetooth CTP gateway transmits a predetermined bluetooth profile to a bluetooth CTP mobile telecommunication terminal to request a CTP connection attempt.

These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a flow diagram illustrating a method of connecting a bluetooth CTP mobile telecommunication terminal to a bluetooth CTP gateway according to one embodiment of the present invention.

FIG. 2 is an exemplary diagram illustrating the operation of the present invention.

### DETAILED DESCRIPTION OF THE PREFERRED EMBODIMENTS

The present invention is directed to a bluetooth CTP mobile telecommunication terminal, a bluetooth CTP gateway, and a connection method thereof such that there is no need to re-register the new position of the CTP gateway in a CTP mobile telecommunication terminal when the position of the CTP gateway is changed. Although the present invention is illustrated with respect to a mobile communication terminal, it is contemplated that the present invention may be utilized anytime it is desired to efficiently connect a CTP bluetooth communication device to a CTP gateway.

Hereinafter, a preferred embodiment of a method of connecting a bluetooth CTP mobile telecommunication terminal to a bluetooth CTP gateway according to the present invention will be described in detail with reference to the accompanying drawings.

Generally, a CTP gateway is relatively less important to reduction of electric power consumption than a CTP mobile telecommunication terminal since a CTP gateway has the characteristics of an immobile device. The present invention utilizes the characteristics of a CTP gateway in order to reduce the power consumption of a CTP mobile telecommunication terminal.

A CTP gateway attempts an SPP connection to a registered CTP mobile telecommunication terminal and the terminal attempts a CTP connection to the CTP gateway through the SPP connection attempt. In this way, power consumption of the CTP mobile telecommunication terminal may be reduced and user convenience increased.

“Bluetooth,” as used herein with respect to CTP connection, is a specification of wireless local area network communication. A bluetooth device (BT device) is required in order to utilize bluetooth. In order to receive bluetooth services, the bluetooth device should be connected to a bluetooth access point (BT access point).

As used herein, a bluetooth CTP mobile telecommunication terminal is a bluetooth device and a bluetooth CTP gateway is a bluetooth access point. However, the CTP mobile telecommunication terminal of the present invention also functions as a wireless telephone, thereby functioning as a portable wireless telephone directly through a wireless network. Furthermore, the CTP gateway of the present invention also includes a function allowing the CTP gateway to be connected to a PSTN (Public Switched Telephone Network) wire telephone network in order to access the wire telephone network.

The term of “Profile” is used herein to refer to the kind, structure and usage of a protocol for each specific application when a bluetooth application is implemented. Specifically, the CTP is a profile in which a protocol used by an L2CAP (Local Link Layer Control and Adaptation Protocol) higher layer of bluetooth protocol layers is a TCS (Telephony Control protocol Specification) binary.

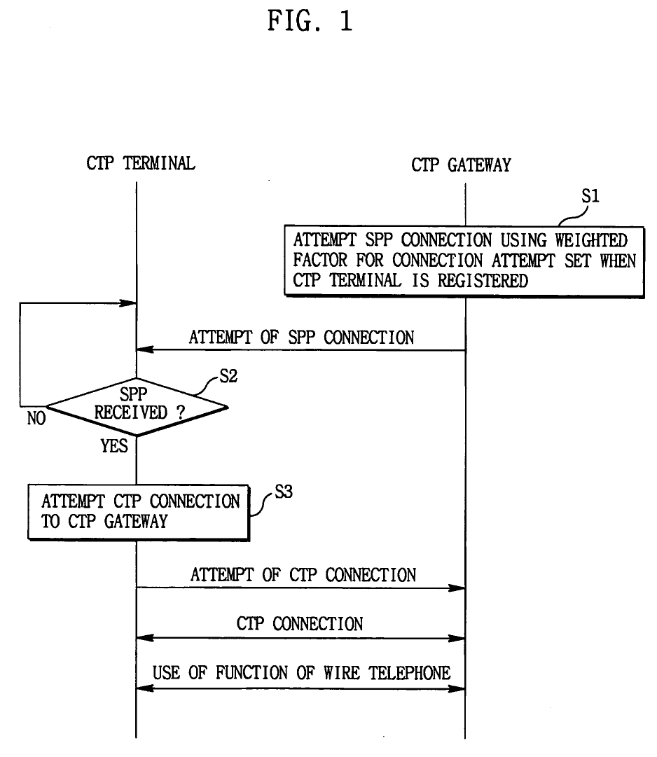

The method of connecting a bluetooth CTP mobile telecommunication terminal to a bluetooth CTP gateway according to the present invention will be described with reference to FIG. 1.

First, the CTP gateway attempts an SPP connection in order to request a CTP connection to the CTP mobile telecommunication terminal (Step S1). The SPP connection attempt is based on a weighted factor that has been set when the CTP mobile telecommunication terminal was registered. At least one CTP mobile telecommunication terminal may be registered in one CTP gateway and the CTP gateway transmits an SPP in order to request CTP connection to at least one CTP mobile telecommunication terminal either sequentially, randomly or based on predetermined priority.

The weighted factor for the connection attempt is set to differentiate the number of SPP connection attempts for requesting the CTP connection to each CTP mobile telecommunication terminal. The weighted factor may be divided into a predetermined number of grades. The weighted factor for a connection attempt is set differently for each CTP mobile telecommunication terminal in accordance with a user's intentional usage pattern or statistical usage for the CTP mobile telecommunication terminal.

If a corresponding CTP mobile telecommunication terminal receives the SPP from the CTP gateway (Step S2), the CTP mobile telecommunication terminal attempts a CTP connection to the CTP gateway (Step S3). The CTP mobile telecommunication terminal may receive the SPP only when the terminal is within a connectable radius within which the terminal can receive the SPP transmitted from the CTP gateway.

Thereafter, if a CTP connection between the CTP mobile telecommunication terminal and the CTP gateway is achieved, the CTP mobile telecommunication terminal may function as a wire telephone through the CTP gateway. Although the CTP gateway preferably uses the simplest SPP bluetooth profile to request CTP connection to all registered CTP mobile telecommunication terminals, the CTP gateway may use all profiles and detection methods defined with regard to bluetooth communication.

FIG. 1 illustrates an embodiment where a fixed value arbitrarily set when a CTP mobile telecommunication terminal was registered is used as a weighted factor for a connection attempt. However, the weighted factor for a connection attempt may vary in other embodiments.

One method of varying weighted factors for a connection attempt is to vary the weighted factor according to an order of terminals having greater frequencies of CTP connection based on statistics for a first predetermined period. Another method of varying weighted factors is by applying a high weighted factor to a terminal in which CTP connection has been maintained within a second predetermined period according to when the CTP gateway attempted SPP connection.

Furthermore, using a combination of both methods, a higher weighted factor may be applied to a terminal having a greater frequency of CTP connection based on statistics for the first predetermined period if there is no terminal in which CTP connection has been maintained within the second predetermined period. The second predetermined period may be relatively shorter than the first predetermined period. Using the various methods for varying weighted factors, the CTP gateway varies weighted factors for a connection attempt to optimally control an SPP connection attempt to a CTP mobile telecommunication terminal.

In one method of differentiating the number of SPP connection attempts by arbitrarily applying priorities, one of a plurality of grades is selected to set a weighted factor for a connection attempt. For example, a plurality of grades, such as first grade through ninth grade, are predetermined when each CTP mobile communication terminal is registered.

As the grade increases or decreases by one grade, the number of connection attempts is doubled or halved. For example, the number of connection attempts may be set in such a manner that the second grade has a number of connection attempts that is twice that of the first grade, the third grade has a number of connection attempts that is four times that of the first grade and the ninth grade has a number of connection attempts that is 512 that of the first grade.

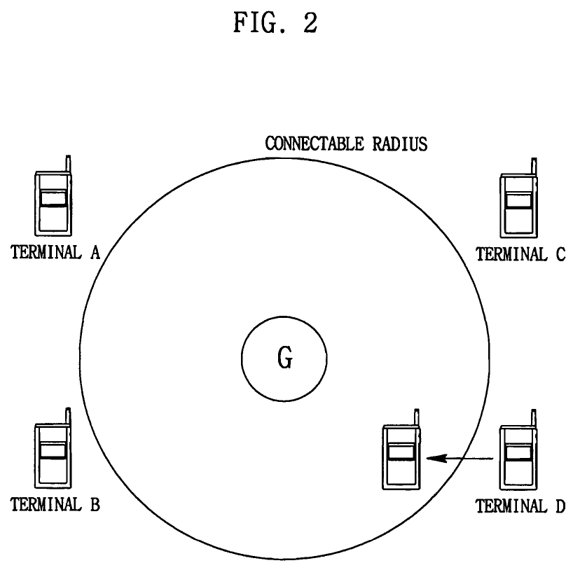

The operation of the present invention utilizing the aforementioned grades will be described with reference to FIGS. 1 and 2. Here, it is assumed that a weighted factor for a connection attempt of a CTP mobile telecommunication terminal registered in a CTP gateway is set by being directly selected from among the predetermined grades by a user when the CTP mobile telecommunication terminal is registered.

First, it is assumed that a user registers four CTP mobile telecommunication terminals (A, B, C, D) in a CTP gateway (G) and then sets weighted factors for a connection attempt of terminals (A, B, C, D) to the first grade, the third grade, the seventh grade and the ninth grade, respectively. In other words, it can be considered that the user most frequently utilizes the terminal (D) set to the ninth grade. The CTP mobile telecommunication terminals (A, B, C, D) are registered in the CTP gateway using a CTP.

When the weighted factors for a connection attempt are set for the respective CTP mobile telecommunication terminals, the CTP gateway (G) attempts the SPP connection a number times corresponding to the weighted factor for a connection attempt during a given time (t). The given time (t) is obtained by excluding a CTP connection standby time (T-t) from a predetermined period of time (T) for requesting CTP connection to each of the CTP mobile telecommunication terminals.

For example, since the four CTP terminals are registered and a ratio of the numbers of connection attempts for A:B:C:D is 1:4:126:512, the CTP gateway attempts to make SPP connection to each of the CTP mobile telecommunication terminals during a time (t) that is divided into 643 (643=1+4+126+512) intervals. The attempts of SPP connection to the respective CTP mobile telecommunication terminals are not continuously maintained. The CTP gateway (G) sustains the ratio only during the 643 intervals and attempts the CTP connection in random order.

As illustrated in FIG. 2, terminals A, B and C are positioned outside a connectable radius. Therefore, when the CTP gateway attempts the SPP connection to the respective CTP mobile telecommunication terminals registered in the CTP gateway according to the aforementioned ratio, neither terminal A, terminal B nor terminal C receives a SPP transmitted from the CTP gateway such that that they do not attempt the CTP connection to the CTP gateway.

However, as terminal D moves from outside the connectable radius into the connectable radius, terminal D receives the SPP transmitted from the CTP gateway and attempts the CTP connection to the CTP gateway. Since the ratio of the number of connection attempts for terminal D is the highest, terminal D immediately receives the SPP when it enters the connectable radius of the CTP gateway (G) and terminal D may immediately attempt CTP connection to the CTP gateway.

Once terminal D and the CTP gateway are inter-connected using the CTP, the wire telephone function of terminal D may be used. It will be apparent that CTP connection to the CTP gateway is attempted only when a user enables the CTP function of each of the terminals A, B, C and D.

Through the procedure described above, the bluetooth CTP mobile telecommunication terminal of the present invention attempts the CTP connection to the CTP gateway only when the CTP mobile telecommunication terminal receives an SPP from the CTP gateway. Therefore, electric power consumption may be reduced and service life of a battery prolonged.

Since the CTP gateway requests a connection attempt by first transmitting an SPP to the CTP mobile telecommunication terminal, there is no need for storing the position of the CTP gateway in the CTP mobile telecommunication terminal. Therefore, even if the position of the CTP gateway is changed, there is no need to re-register the new position of the CTP gateway.

Since connection between the CTP mobile telecommunication terminal and the CTP gateway is implemented using only bluetooth technology, additional costs related to use of another technology, such as CDMA or GPS technology, are reduced. Therefore, a lower cost may be achieved.

Since priority is allocated on the basis of weighted factors for a connection attempt when CTP mobile telecommunication terminals are registered in a CTP gateway, a CTP terminal having higher priority according to a user's usage pattern can immediately perform the function of a wire telephone when the CTP terminal enters the radius of the CTP gateway. Furthermore, the weighted factors for a connection attempt may be varied according to usage conditions such that optimum CTP connection may be achieved.

Although the present invention has been described in connection with the preferred embodiment, it is not limited thereto. It will be readily understood by those skilled in the art that various modifications and changes can be made thereto without departing from the technical spirit and scope of the present invention defined by the appended claims. The modifications and changes should not be construed independently from the spirit and scope of the present invention.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method of connecting at least one bluetooth CTP (Cordless Telephony Profile) mobile telecommunication terminal to a bluetooth CTP gateway, the method comprising:
the CTP gateway transmitting a bluetooth profile to the at least one bluetooth CTP mobile telecommunication terminal registered in the CTP gateway, the profile requesting a CTP connection attempt; and
the at least one terminal attempting a CTP connection to the CTP gateway upon receiving the profile.

2. The method of claim 1, further comprising using a wire telephone network through the CTP gateway when the CTP connection is made between the CTP mobile telecommunication terminal and the CTP gateway.

3. The method of claim 1, wherein the bluetooth profile comprises an SPP (Serial Port Profile).

4. The method of claim 1, further comprising the CTP gateway setting a weighted factor for the connection attempt, the weighted factor differentiating a number of requests corresponding to connection attempts for each of a plurality of CTP mobile telecommunication terminals registered in the gateway.

5. The method of claim 4, wherein setting the weighted factor comprises a method based on at least one of a frequency of connection of the at least one CTP mobile telecommunication terminal to the CTP gateway and whether the at least one CTP mobile telecommunication terminal has been connected to the CTP gateway within a predetermined period of time, the predetermined period of time based on a point in time when a connection attempt was made.

6. The method of claim 4, further comprising selecting the weighted factor from at least one grade such that a number of requests corresponding to a specific connection attempt increases or decreases by a predetermined multiple between any two successive grades.

7. The method of claim 6, further comprising requesting the CTP connection attempt up to a maximum number of times equal to a sum of the numbers of connection attempts corresponding to the weighted factors of a number of CTP mobile telecommunication terminals registered in the CTP gateway.

8. The method of claim 7, further comprising requesting the CTP connection attempt during a time obtained by excluding a CTP connection standby time from a predetermined period of time.

9. A bluetooth CTP mobile telecommunication terminal for connecting to a bluetooth CTP gateway, wherein the terminal is adapted to attempt a CTP connection to the gateway only upon receiving a bluetooth profile transmitted from the gateway, the profile requesting the CTP connection attempt.

10. The terminal of claim 9, wherein the CTP gateway is adapted to connect to a wire telephone network.

11. The terminal of claim 10, wherein the bluetooth profile comprises an SPP.

12. The terminal of claim 10, wherein the CTP gateway sets a weighted factor for the connection attempt, the weighted factor differentiating a number of requests corresponding to connection attempts for each of a plurality of CTP mobile telecommunication terminals registered in the gateway.

13. The terminal of claim 12, wherein the connection attempt is requested during a time obtained by excluding a CTP connection standby time from a predetermined period of time.

14. A bluetooth CTP gateway adapted to connect to a wire telephone network and at least one bluetooth CTP mobile telecommunication terminal, wherein the gateway is further adapted to transmit a predetermined bluetooth profile to the at least terminal, the profile requesting a CTP connection attempt.

15. The gateway of claim 14, wherein the connection to the wire telephone network is provided when the CTP connection is made a bluetooth CTP mobile telecommunication terminal registered in the gateway.

16. The gateway of claim 14, wherein the bluetooth profile is an SPP.

17. The gateway of claim 14, further adapted to set a weighted factor for the connection attempt, the weighted factor differentiating a number of requests corresponding to connection attempts for each of a plurality of CTP mobile telecommunication terminals registered in the gateway.

18. The gateway of claim 17, further adapted to set of the weighted factor using a method based on at least one of a frequency of connection of the at least one CTP mobile telecommunication terminal to the gateway and whether the at least one CTP mobile telecommunication terminal has been connected to the gateway within a predetermined period of time, the predetermined period of time based on a point in time where the connection attempt was made.

19. The gateway of claim 18, further adapted to select the weighted factor from at least one grade such that a number of requests corresponding to a specific connection attempt increases or decreases by a predetermined multiple between ay two successive of the plurality of grades.

20. The gateway of claim 19, further adapted to request the CTP connection attempt up to a maximum number of times to a sum of the numbers of connection attempts corresponding to the weighted fractors of a number of CTP mobile telecommunication terminals registered in the gateway.

21. The gateway of claim 20, further adapted to request the CTP connection attempt during a time obtained by excluding a CTP connection standby time from a predetermined period of time.
